(19) United States
(12) Patent Application Publication
(10) Pub. No.: US 2004/0169982 A1
(43) Pub. Date: Sep. 2, 2004

(54) Surge protector

(76) Inventors: Terry Wayne Bunton, Mooresville, IN (US); Peter Ronald Knight, Noblesville, IN (US)

Correspondence Address: JOSEPH S. TRIPOLI, PATENT OPERATIONS, THOMSON LICENSING INC., P. O. BOX 5312, PRINCETON, NJ, 08543-5312, US

(21) Appl. No.: 10/755,103

(22) Filed: Jan. 9, 2004

Related U.S. Application Data
(60) Provisional application No. 60/450,585, filed on Feb. 27, 2003.

(51) Int. Cl. H02H 9/06; H02H 3/22

(52) U.S. Cl. 361/111; 361/118

(57) ABSTRACT

In order to protect a load from surges which may occur on an AC line, a pair of metal oxide varistors (MOV) are serially coupled across the AC line. A series circuit of a gas tube and a capacitor is coupled from the terminal which joins the two varistors to ground.

### BACKGROUND

This invention relates to apparatus for protecting against surges which may occur on AC lines. Such surges are often caused by atmospheric discharges, such as lightning. Surges can cause damage to sensitive electronic equipment. It is therefore desirable to bypass surges to an earth ground.

In some AC distribution systems, such as in older homes, an earth ground is not readily available. Surge protection arrangements may therefore bypass surges to a chassis ground which is not conductively coupled to either of the AC line conductors. Such a chassis is known as a “cold” chassis.

A cold chassis often has portions which are accessible to the operator of the apparatus. It is therefore important to make certain, as far as possible, that a cold chassis does not acquire a conductive path to either of the AC lines, which would create an electrical shock hazard. One form of prior art surge protector takes the form of a slotted spark gap positioned on a circuit board. Such a spark gap will become conductive during a surge which exceeds a predetermined value, so as to bypass the surge away from the electronic equipment to a chassis ground. Unfortunately, a slotted spark gap may become permanently conductive, due to dirt or ionization, thus coupling the AC line to chassis ground, possibly exposing the operator to a shock hazard.

Another prior art surge protector uses a pair of series coupled metal oxide varistors (MOV) across the AC conductors. The junction between the two MOV's is coupled through a gas tube spark gap to chassis ground. This is much better than a slotted spark gap because a short circuited gas tube will be isolated from the AC line by the MOV's. However, a non-conductive MOV may have an impedance which is low enough to couple a current to ground sufficient to create a shock hazard, if the gas tube becomes short circuited.

### SUMMARY OF THE INVENTION

The instant invention provides a surge protector comprising a spark gap in series with a non-conductive path to a common conductor, such as chassis ground. This provides a double protection against shock hazard. More specifically, the invention provides a surge protector for protecting a load from surges which may occur on an AC line coupled to the load. The surge protector comprises a first series circuit of a spark gap and a capacitor coupled to the AC line.

### DETAILED DESCRIPTION

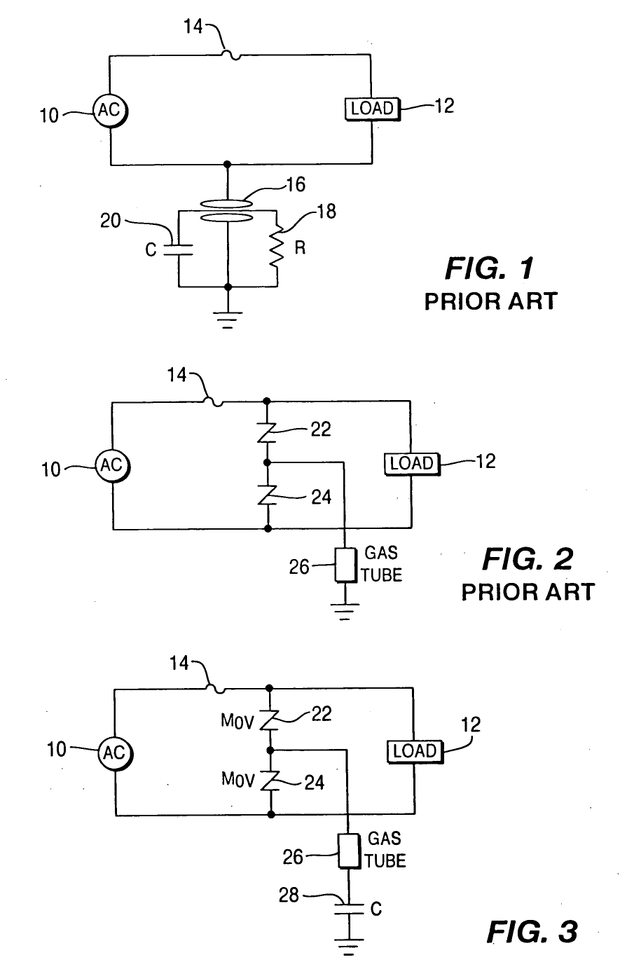

FIG. 1 shows a prior art surge protection arrangement. An AC source 10 powers a load 12 through fuse 14. A slotted spark gap 16 is coupled from one side of the AC source to chassis ground, which may be conductively isolated from the AC source, through resistor 18 and capacitor 20 coupled in parallel. A surge on the AC line will cause the spark gap 16 to conduct, so as to bypass the surge to chassis ground, so as to protect load 12 from the surge. If, for some reason, spark gap 16 becomes conductive, resistor 18 will provide a conductive path to chassis ground, which may create a shock hazard.

FIG. 2 shows another prior art surge protection arrangement in which a pair of impedances, such as metal oxide varistors (MOV) 22, 24, are coupled across the AC lines through fuse 14. The junction of the varistors is coupled to ground through a spark gap such as gas tube 26. A surge on either of the AC lines will cause one or both of the MOV's to conduct. Gas tube 26 will conduct, and the surge will be bypassed to chassis ground.

Although an MOV has a high resistance when non-conductive, there may be enough leakage through such a non-conductive MOV to create a shock hazard, if gas tube 126 of FIG. 2 fails in a conductive state.

FIG. 3 illustrates a surge protector according to the invention. The arrangement of FIG. 3 is similar to that shown in FIG. 2, except that the spark gap, such as gas tube 26, is coupled to a common conductor, such as chassis ground, through a non-conductive path, such as capacitor 28, which may have a value of 470 pF. Capacitor 28 provides a path to chassis ground for a surge, without providing a conductive path which might produce a shock hazard.

1. A surge protector for protecting a load from surges which may occur on an AC line coupled to said load, said surge protector comprising a pair of impedances coupled across said AC line, and a series circuit of a spark gap and a capacitor coupled to said impedances.

2. A surge protector according to claim 1 in which said series circuit is coupled to a common conductor.

3. A surge protector according to claim 1 in which said spark gap is a gas tube.

4. A surge protector according to claim 1 in which said series circuit is coupled to a terminal between said impedances.

5. A surge protector according to claim 4 in which said impedances are metal oxide varistors.
